(19) United States
(12) Patent Application Publication
(10) Pub. No.: US 2014/0059498 A1
(43) Pub. Date: Feb. 27, 2014

(54) USER INTERFACE DISPLAY OF ANCHOR TILES FOR RELATED ENTITIES

(71) Applicants: Michael McCormack, Snohomish, WA (US); Ron Mondri, Bellevue, WA (US); Ted Cyrek, Sammamish, WA (US); Anastasia Paushkina, Redmond, WA (US); Naveen Kumar Sethia, Hyderabad (IN); Christian Heydemann, Kirkland, WA (US); Richard Lee Dickinson, Seattle, WA (US)

(72) Inventors: Michael McCormack, Snohomish, WA (US); Ron Mondri, Bellevue, WA (US); Ted Cyrek, Sammamish, WA (US); Anastasia Paushkina, Redmond, WA (US); Naveen Kumar Sethia, Hyderabad (IN); Christian Heydemann, Kirkland, WA (US); Richard Lee Dickinson, Seattle, WA (US)

(73) Assignee: Microsoft Corporation, Redmond, WA (US)

(21) Appl. No.: 13/594,881

(22) Filed: Aug. 27, 2012

(51) Int. Cl. G06F 3/048

(52) U.S. Cl. 715/854

(57) ABSTRACT

A display is generated for displaying entities that are related to a selected entity. The display includes one or more tiles, each tile displaying a representation of a selected entity and associated entities, within that single tile.

### BACKGROUND

Many database systems contain data arranged as entities or entities that are associated with one another. Often, the associations between different entities can be quite complex. Generating a user interface display that allows a user to view the associated entities, in a somewhat comprehensive way, can be very difficult.

By way of example, some business applications contain a large number of related entities. For instance, customer resource management (CRM), enterprise resource planning (ERP) or line-of-business (LOB) applications are all business applications that can include a large number of entities. Some exemplary entities include entities that represent customers, contacts, business opportunities, purchase orders, quotes, deliverables, etc. These and other entities can be associated with one another in a variety of different relationships. Some examples of common entity relationships are one-to-one relationships, one-to-many relationships, many-to-many relationships or one-to-one-to-many relationships. In many cases, information in related entities is represented, when displaying a selected entity, in the form of lists which have little intuitive meaning to the user.

Small screen devices are also gaining popularity among workers in organizations. For instance, many workers conduct business from small screen devices, such as cellular telephones, tablet computers, smart phones, multimedia players, personal digital assistants, etc. These types of devices have smaller display screens than, for example, desktop computers with full size monitors. Therefore, the problem of displaying relatively complex associations between various entities is exacerbated as the size of the screen used for the display becomes smaller.

The discussion above is merely provided for general background information and is not intended to be used as an aid in determining the scope of the claimed subject matter.

### SUMMARY

A display is generated for displaying entities that are related to a selected entity. The display includes one or more tiles, each tile displaying a representation of a selected entity and associated entities, within that single tile.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one embodiment of a business data system.

FIG. 2 is one exemplary illustration of an object association diagram showing associated entities or entities.

FIG. 3 is a flow diagram illustrating one embodiment of the operation of the system shown in FIG. 1.

FIG. 4 shows one embodiment of a variety of different user interface display tile sizes in an exemplary layout.

FIGS. 5-7 show exemplary user interface displays illustrating different arrangements of tiles and different tile sizes.

FIGS. 8A-8G illustrate exemplary user interface display tiles.

FIG. 9 shows one embodiment of a cloud computing architecture.

FIGS. 10-13 illustrate various examples of mobile devices.

FIG. 14 is a block diagram of one embodiment of a computing environment.

### DETAILED DESCRIPTION

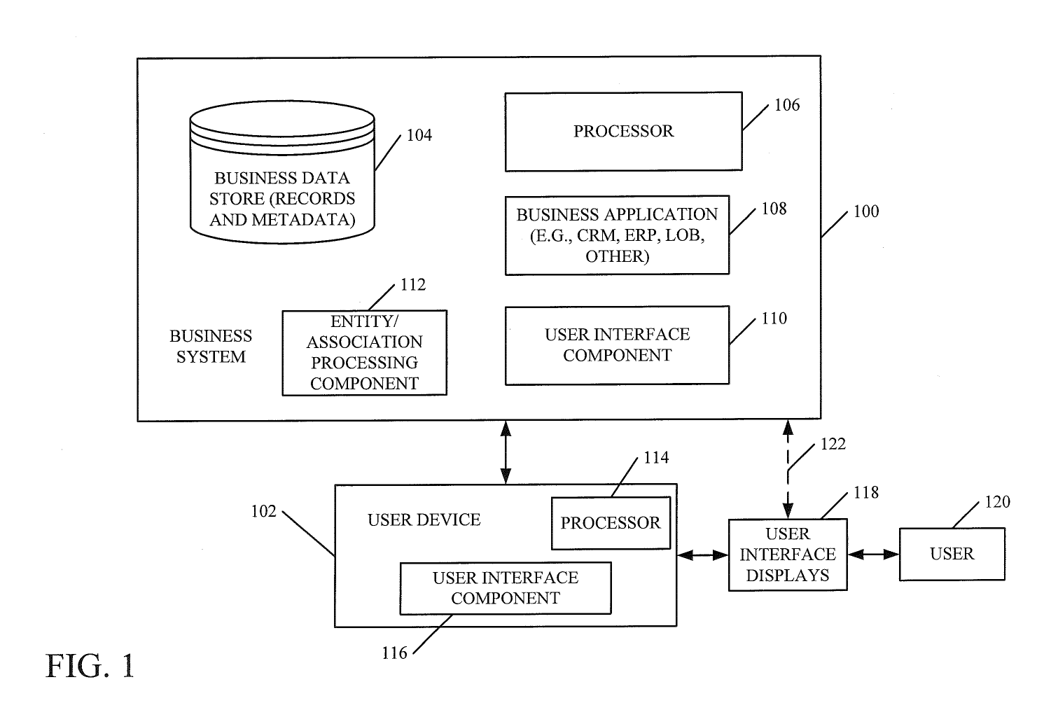

FIG. 1 is a block diagram of one embodiment of a business system 100 coupled to a user device 102. In the embodiment shown in FIG. 1, business system 100 includes business data store 104 that has records and metadata. System 100 also includes processor 106, business application 108, user interface component 110 and entity/association processing component 112. FIG. 1 also shows that user device 102 illustratively includes processor 114 and user interface component 116. In one embodiment, a user 120 interacts either directly with business system 100 (as indicated by dashed arrow 122) or interacts with system 100 through user device 102. In either case, user interface displays 118 are generated for user 120. User interface displays 118 illustratively include user input mechanisms that user 120 can interact with in order to access and control system 100. This can either be done through a user device 102 or directly.

Processor 106 is illustratively a computer processor with associated timing and memory circuitry (not shown). Processor 106 is a functional component of business system 100 and is activated by, and facilitates the functionality of, other applications and components in business system 100.

Processor 114 is illustratively a computer processor with associated timing and memory circuitry (not shown). Processor 114 is a functional component of user device 102 and is activated by, and facilitates functionality of, other components or applications on user device 102.

User interface components 110 and 116 illustratively generate the user interface displays 118 and receive inputs through the user input mechanisms on those displays or using other user input mechanisms. Again, the user interface displays 118 can be generated from user interface component 110, user interface component 116, or both.

In one embodiment, business application 108 is a customer relations management (CRM) application, an enterprise resource planning (ERP) application, a line-of-business (LOB) application, or another type of business application. Business application 108 illustratively generates, accesses, manipulates and stores business data in business data store 104. The business data can include, for example, records and associated metadata. The business records may be represented by objects or entities that are associated with one another and that include metadata that defines, among other things, the associations among the various objects or entities. While the term entity normally refers to a more rich item, in terms of functionality, than an object, it will be used herein to include both entities and objects. User 120 illustratively interacts, through user interface displays 118 or using other user input mechanisms (such as a point and click device, a keyboard, a touch sensitive screen, voice inputs, etc.) with business application 108 to access and manipulate the business data in data store 104.

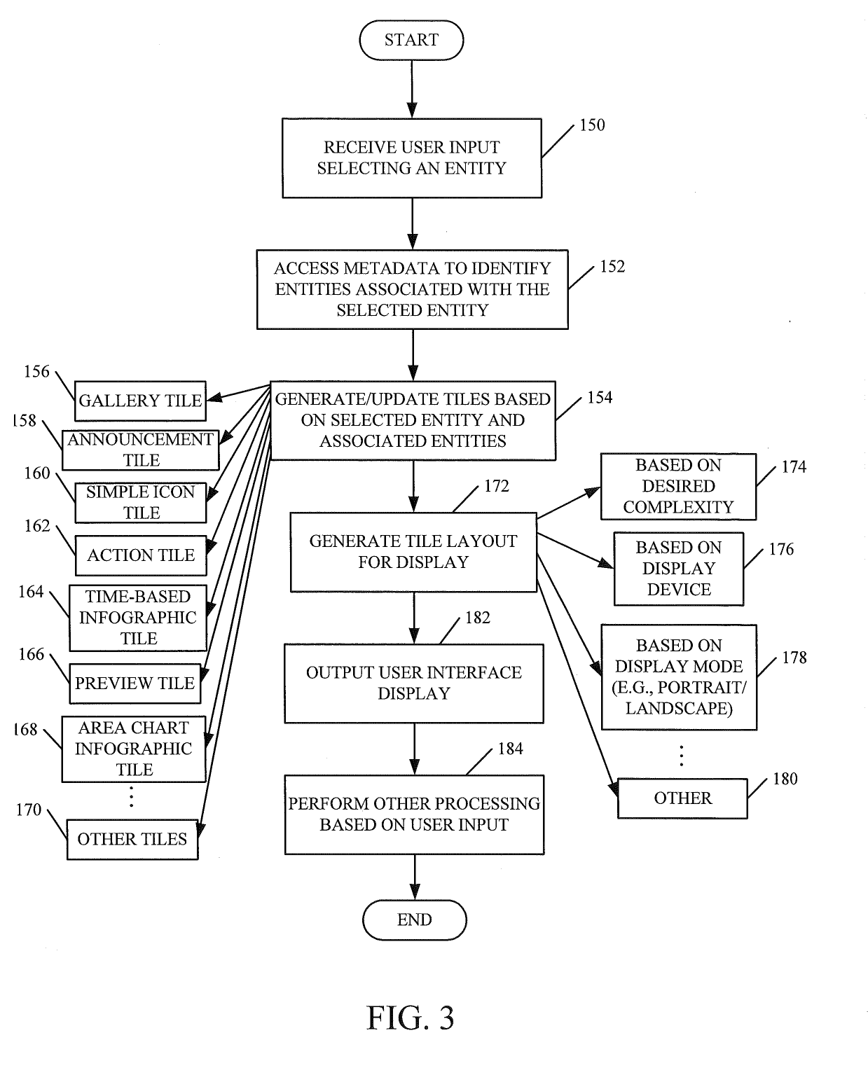

As user 120 accesses business application 108, it may be desirable to have user 108 view the information corresponding to not only a selected entity, but other entities that are associated with the selected entity. In addition, user 120 may wish to actually interact with, or navigate to, the other entities that are associated with the selected entity. Therefore, in generating user interface displays 118 for user 120, it can be helpful to generate the user interface displays 118 such that they depict information corresponding not only to a selected entity, but to associated entities as well. In one embodiment, business system 100 receives a selection input from user 120 selecting an entity. Entity/association processing component 112 illustratively accesses in data store 104 that identifies the various different types of entities associated with the selected entity and the types of associations. User interface component 110 (or user interface component 116) generates user interface displays 118 to display information corresponding to the selected entity and associated entities, in a way that may be helpful to user 120. One embodiment of the operation of system 100 in doing this is described below with respect to FIG. 3. Prior to describing the operation in greater detail, however, a brief example of associated entities will be discussed.

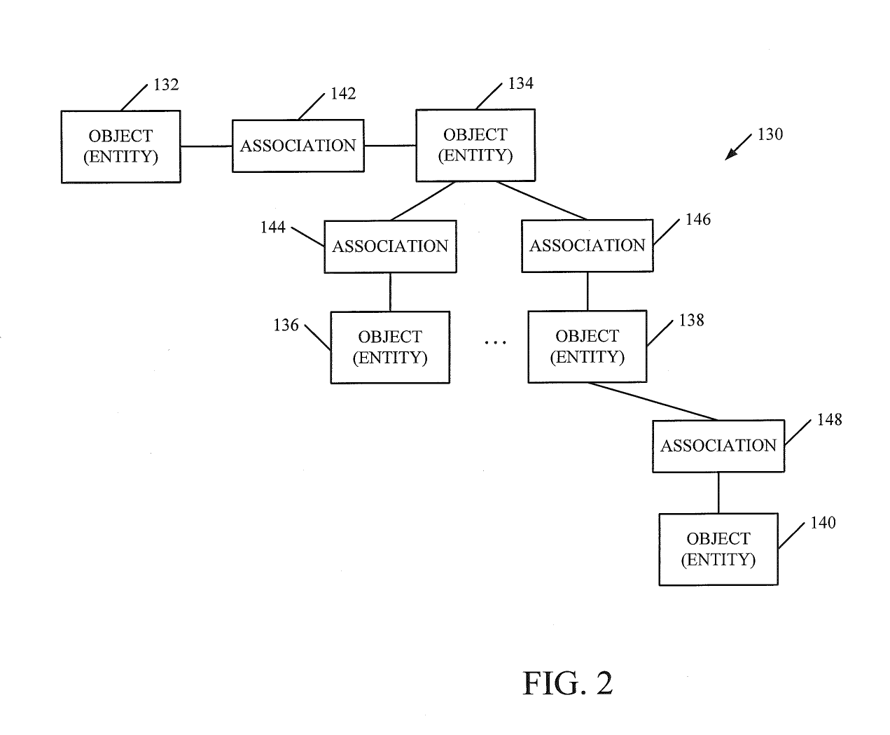

FIG. 2 illustrates an association diagram 130 that shows a plurality of entities 132, 134, 136, 138 and 140. The entities are associated with one another in one of a variety of different types of associations. FIG. 2 illustrates this by showing that entities 132 and 134 are associated with one another by association 142. Entity 134 is associated with entity 136 by association 144 and entity 134 is also associated with entity 138 by association 146. FIG. 2 also shows that entity 138 is associated with entity 140 by association 148.

Associations 142-148 can be any of a wide variety of different types of associations. For instance, the associations can be one-to-one relationships, one-to-many relationships, many-to-many relationships or one-to-one-many relationships (and these are examples only). Assume, by way of example, that entity 134 is an entity that represents a sales opportunity (or an opportunity). In that case, entity 136 may be a “quotes” entity that represents one or more quotes that have been made to the organization identified in opportunity entity 134. Similarly, entity 138 may be a “contact” entity that represents the primary contact for the organization represented by opportunity entity 134. Entity 140 may represent a contact entity that identifies the contact information for the person represented by entity 138. Of course these are exemplary only and a wide variety of different or additional entities and associations can be used as well.

In any case, it may be helpful to user 120 that, when user 120 selects entity 134 for display, related or associated entities 132, 136 and 138 (and perhaps entity 140) be represented to the user as well. Display elements corresponding to the associated entities can provide meaningful context and direct navigation to those entities, even when the user is viewing entity 134. Presenting this information in a consistent and meaningful way may be helpful to user 120.

FIG. 3 is a flow diagram showing the operation of system 100 according to one illustrative embodiment. User 120 first interacts with business application 108 through user interface displays 118 to select an entity to be displayed. The application 108 receives that selection, and this is indicated by block 150 in FIG. 3. Entity/association processing component 112 then accesses data in data store 104 based upon the selected entity and identifies other entities that are associated with the selected entity. This can be obtained by accessing metadata associated with the selected entity to identify which other entities are associated with it, and the types of association. The metadata for the selected entity can identify a priority of associations or associated entities and the highest priority items can then be displayed. The number of displayed items and the particular display layout used to display them, can depend on a variety of things, such as the device displaying the items, the size of the display, user preferences, etc. Of course, other considerations can be used in determining which items (entities, associations, etc.) to display. Component 112 can then generate a suitable user interface (displayed items in a suitable layout), using user interface component 110, for display to user 120. Accessing the metadata to identify entities associated with the selected entity and corresponding metadata is indicated by block 152 in FIG. 3.

The user interface displays 118 generated based on the selected entities and associated entities can take a wide variety of different forms. In one embodiment, the user interface displays 118 include a plurality of tiles that are generated based on the selected entity and the associated entities, and the types of associations and metadata identified using component 112. It may also happen that the selected entity may have been selected previously by a user. In that case, the user interface displays (e.g., the tiles) may have already been generated and stored in business data store 104. Therefore, the tiles are simply accessed and updated, in case any new entities have been generated and associated with the selected entity, or in case any have been deleted or otherwise modified. Generating or updating the tiles based on the selected entity and associated entities is indicated by block 154 in FIG. 3.

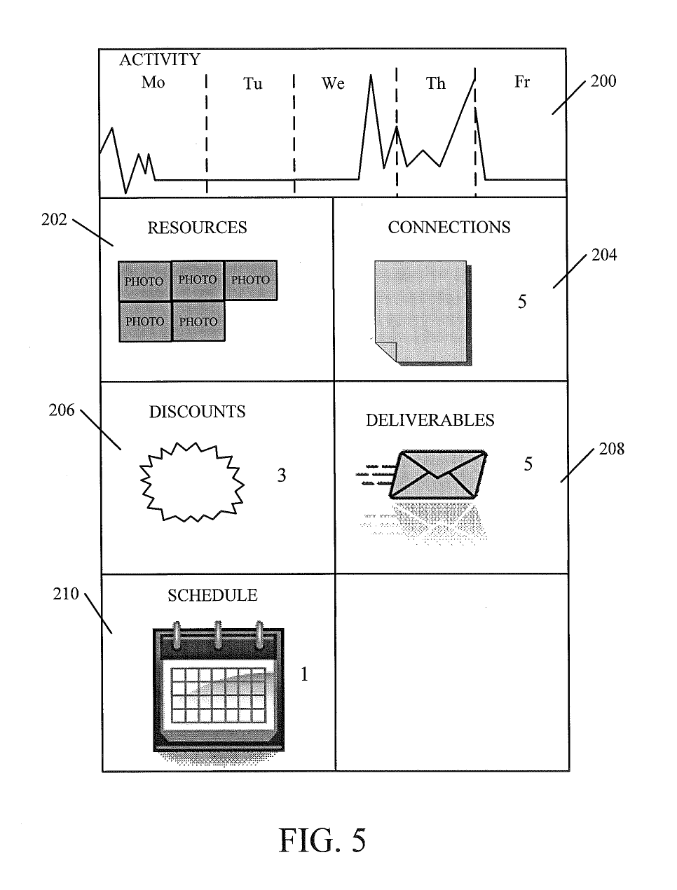

As will be described below with respect to FIGS. 5-8G, the tiles can take a wide variety of forms. Some examples of tiles include gallery tile 156, announcement tile 158, simple icon tile 160, action tile 162, time-based info-graphic tile 164, preview tile 166, area chart info-graphic tile 168, or other tiles 170. The tiles represent not only the selected entity, but entities that are associated with the selected entity, and the types of associations. Again, examples of these will be discussed below.

Once the tiles are generated, user interface component 110 generates a tile layout for displaying the tiles on user interface displays 118. Generating the tile layout for display is indicated by block 172 in FIG. 3. The tile layout (as briefly mentioned above) can be generated based on a wide variety of different criteria. The layout may have different complexities as indicated by block 174. By way of example, the complexity may be basic complexity in which case only a single column of tiles is displayed, or it may be medium complexity in which case two columns of tiles are displayed. Also, by way of example only, the complexity may be high or complex, in which case three or more columns of tiles are displayed on user interface displays 118. It will be noted, of course, that these complexity levels are exemplary only and different or additional complexity levels could be used as well.

The tile layout may also be based on the display device (such as user device 102) on which the user interface display 118 is being generated. This is indicated by block 176 in FIG. 3. For example, where the user device 102 is a desktop computer with a relatively large display mechanism and high resolution, the display may take a first form. On the other hand, where user device 102 is a slate computer or other mobile device such as a smart phone, a cell phone, a multimedia player, etc., the layout may take a different form.

In addition, the tile layout may be based on the display mode, which can be predefined or selected by the user. This is indicated by block 178 in FIG. 3. For instance, the display mode may be portrait or landscape, or another display mode. In that case, the user interface display 118 will change to accommodate the selected display mode. Of course, other criteria 180 can be used to generate the tile layout as well.

Once the tiles have been generated or updated and the tile layout has been determined, the user interface display 118 is output for display to the user. This is indicated by block 182 in FIG. 3. This can be done directly by business system 100, or through a user device 102.

Once the user interface displays 118 are displayed to the user, user device 102 or business system 100 can then perform other processing based on user inputs. For instance, the user may select one of the tiles in which case the entity, and associated entities, are displayed for that tile. The user may navigate to different entities, by actuating the associated tile, through the user interface or select other attributes or information to be displayed. Other processing can be performed based on user inputs as well. Performing processing based on user inputs is indicated by block 184 in FIG. 3.

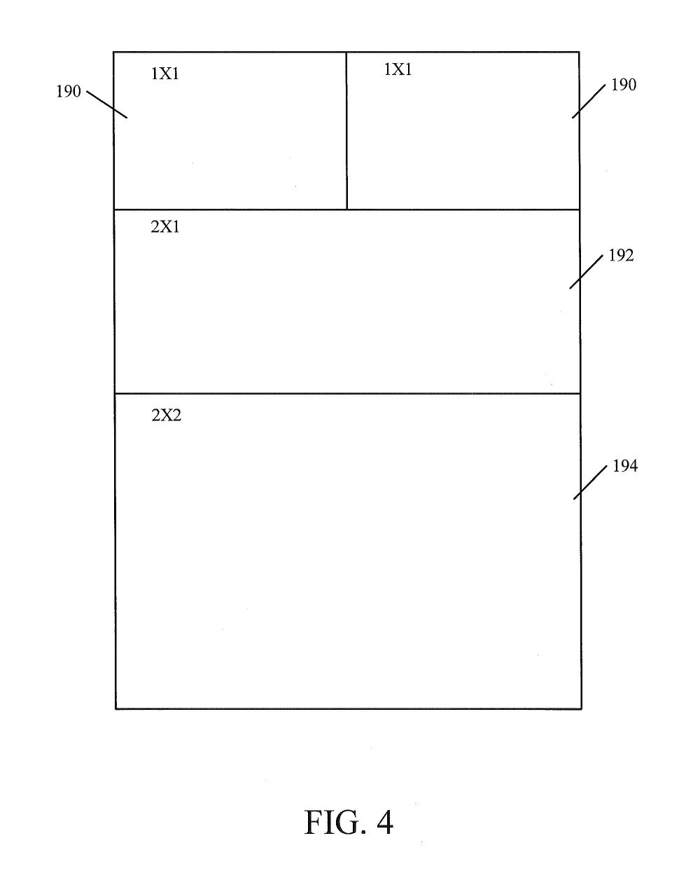

FIG. 4 is a diagram showing one embodiment of different tile sizes that can be used. Of course, the tile sizes shown in FIG. 4 are by way of example only. FIG. 4 shows that tiles can be generated in a 1×1 size shown by tiles 190. The tiles can also be generated in a 2×1 size shown by tile 192 or in a 2×2 size shown by tile 194. Of course, the tiles can be many different sizes and these are illustrated by way of example only. In addition, the tiles can be relative in size and based on the size of the display screen on which they are displayed, or based on other criteria. That is, the 1×1 tile may be one inch by one inch, one centimeter by one centimeter, one set of pixels by one set of pixels, etc. The dimensions shown in FIG. 4 are intended to give relative dimensions where the tiles are measured relative to one another only, and no absolute measurements are intended by the figure. Of course, the tiles can be generated in other ways, in which their size is not relative to the size of other tiles in any way. These are given by way of example only.

In one embodiment, since the tiles are generally square and exist in a group, the relative size restrictions provide layouts with easy alignment and distribution in a variety of different groups. FIG. 5 shows one illustrative group of tiles in which tiles 200, 202, 204, 206, 208 and 210 are generated in a layout and displayed on a user interface display 118. It can be seen that tile 200 is a 2×1 tile, while the remaining tiles 202-210 are 1×1 tiles. Again, it is assumed that the user has selected an entity and files 200-210 all corresponding to entities that are somehow related to, or associated with, the selected entity.

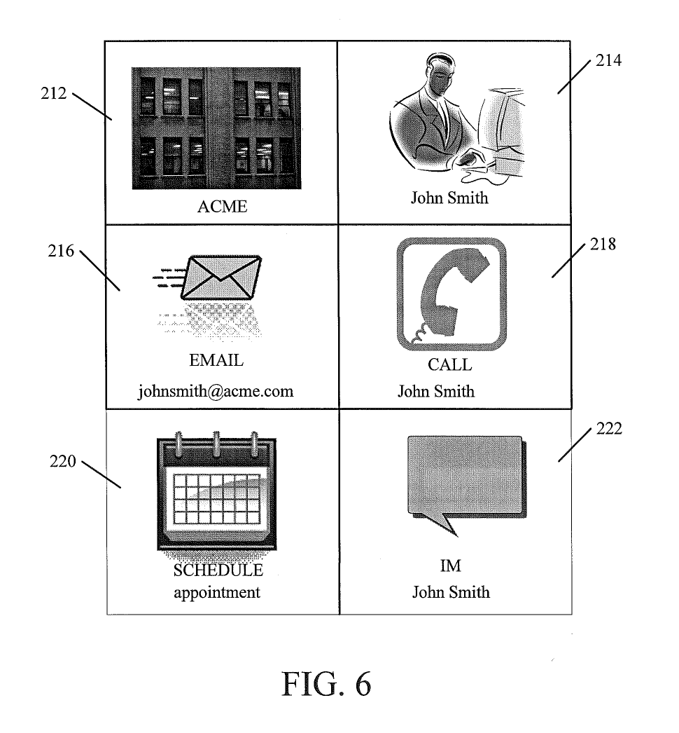

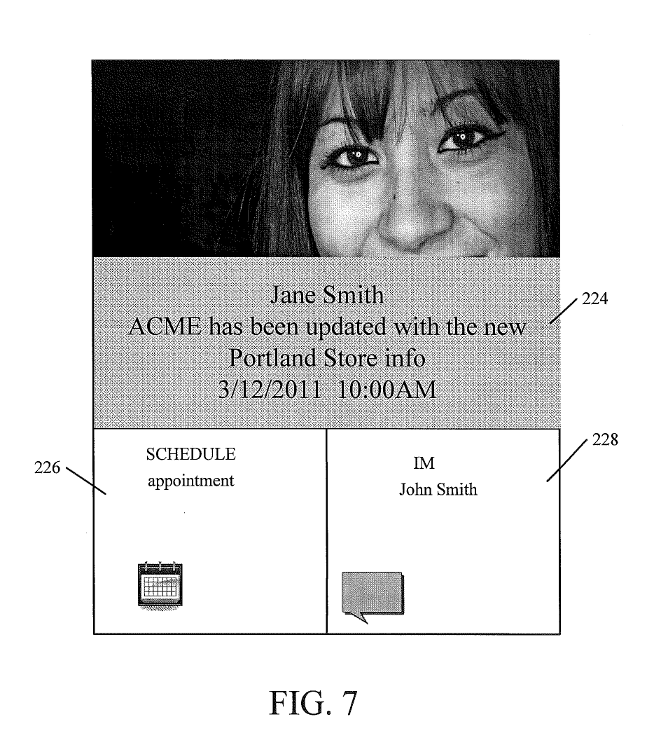

FIG. 6 shows a second layout template in which tiles 212, 214, 216, 218, 220 and 222 are generated, and each of the tiles 212-222 are a 1×1 tile. FIG. 7 shows yet another exemplary layout template that includes exemplary tiles 224, 226 and 228. It can be seen that tile 224 is a 2×2 template while tiles 226 and 228 are 1×1 tiles.

It should be noted that the tile layout shown in FIGS. 5-7 can be generated based on user selection of an underlying entity. For example, referring again to FIG. 5, it may be that the user has selected a “customer” entity through a suitable user interface display. In that case, tiles 200-210 reflect entities that are associated with the selected “customer” entity. Tile 200, for instance, shows activity over the previous week for the selected customer. If the user selects tile 200, the user can be taken to the source information corresponding to that activity. Tile 202 shows a gallery of people who are somehow related to the customer. Tile 204 shows other connections, such as people or other customers or vendors, that are related to the selected customer. Tile 206 shows that there are three discounts that have been given to that customer. Tile 208 shows five different deliverables specified for that customer, and tile 210 shows a schedule of events or other happenings that are related to that customer. When the user selects any of the tiles 200-210, a new set of tiles is generated or updated and the user is navigated to the information corresponding to the selected tile.

It will be appreciated that entity/association processing component 112 can be used to generate a variety of different tiles based on the different types of associations among the entities that are related to the selected entity. A number of those tiles will now be described. Of course, it will be appreciated that the user interface displays can take other forms, other than tiles, but tiles provide a mechanism by which a large amount of information related to a selected entity can be displayed in a navigable and precise form, in a relatively limited space.

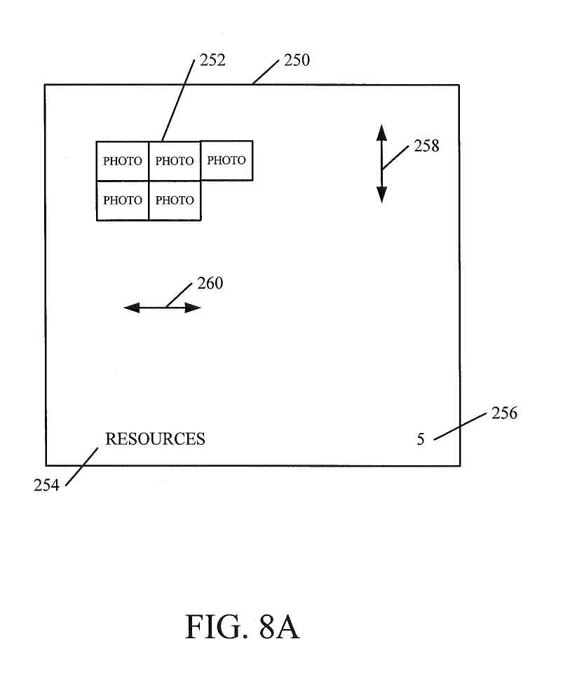

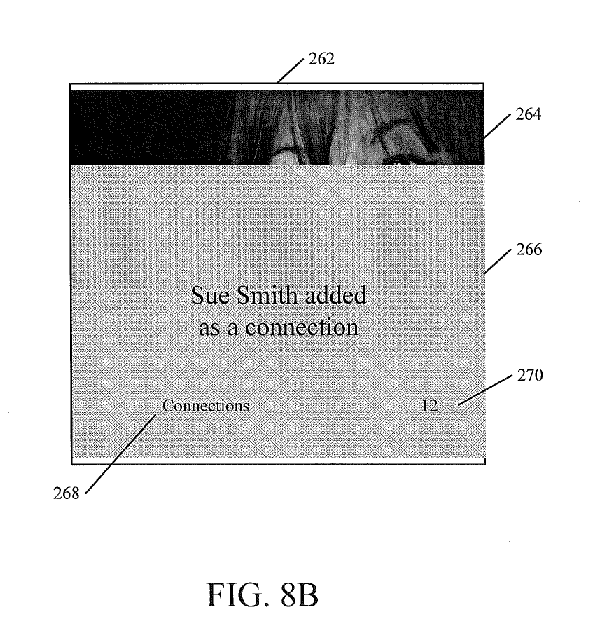

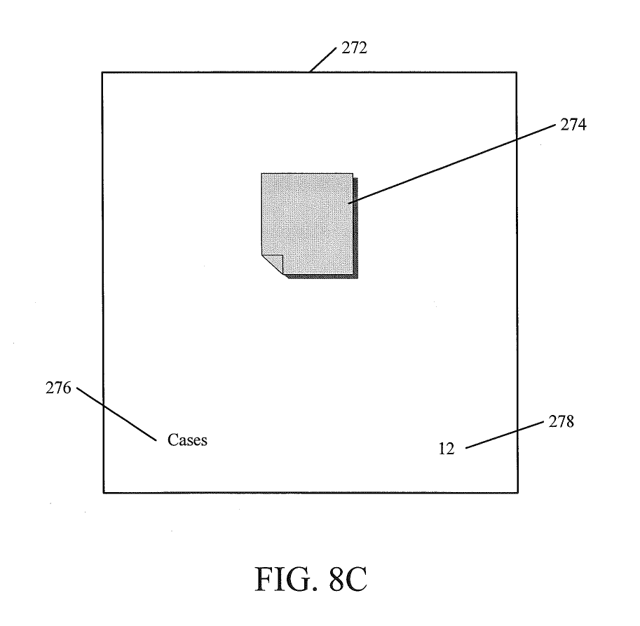

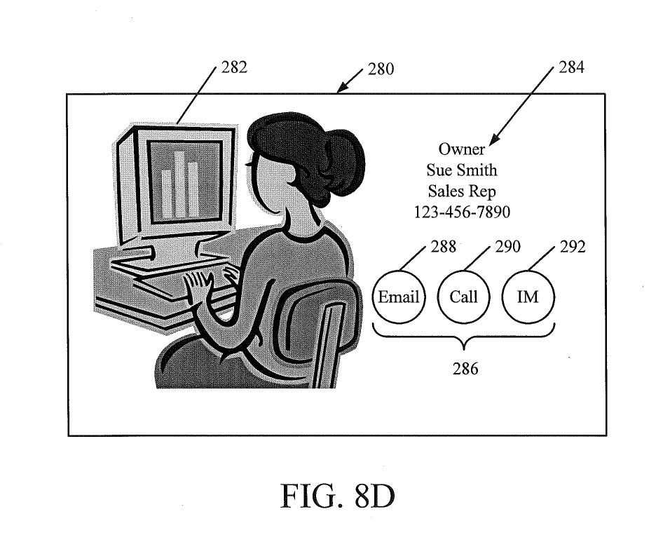

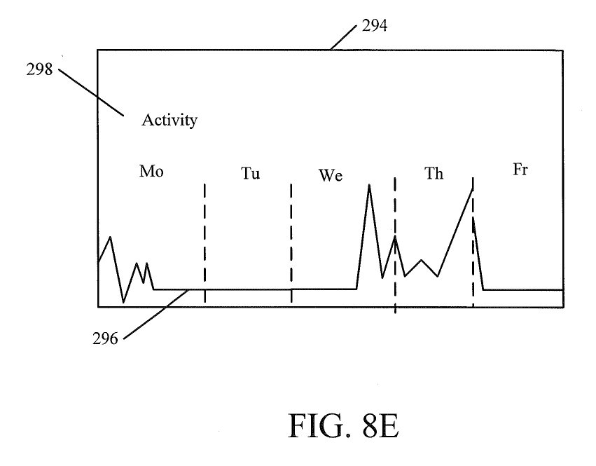

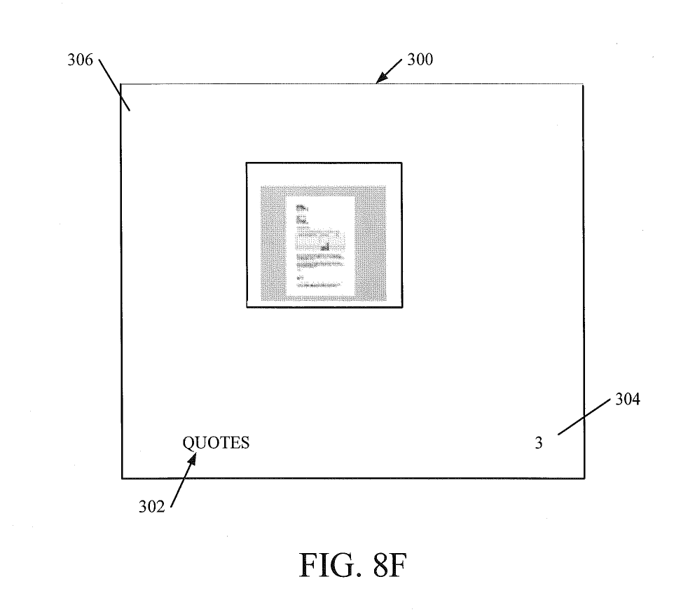

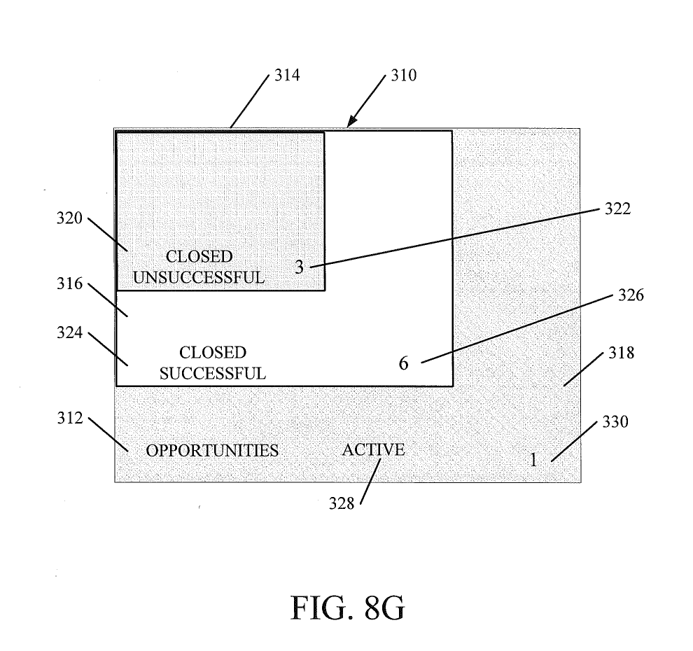

In any case, FIG. 8A illustrates a gallery tile 250. Gallery tile 250 is illustratively used to display a collection of images that are related to the central entity (or selected entity). In the embodiment shown in FIG. 8A, gallery tile 250 shows a collection of photographs 252. The photographs are of people that are related to the selected entity. For instance, as discussed above, where a “customer” entity has been selected, the photographs 252 may identify contacts at that customer, or vendors for that customer, or other individuals related to the selected customer entity. The photographs 252 may also be photographs showing all people working at a particular company, and this information can be obtained from the company records in business data store 104 (shown in FIG. 1). Of course, while tile 250 in FIG. 8A shows that photographs 252 are of people, they could also be other images representing related records. For instance, they may be images of products manufactured by the customer, or other images as well.

FIG. 8A also shows that the bottom portion of tile 250 contains additional information. The bottom portion of tile 250 includes an icon 254 which, when actuated by the user 120, navigates the user to other related entities that are identified by tile 250. The count indicator 250 illustrates a number of other entities that are related entities.

It will also be noted that, while tile 250 shows images 252 in a static display, that is exemplary only. For instance, it may be that there are a large number of related records so that the number of images 252 is too large to display statically on a single tile 252. In that case, the user interface component used to generate tile 250 can give the tile dynamic characteristics so that images 252 can be scrolled vertically, in the direction indicated by arrow 258, or horizontally in the direction indicated by arrow 260, or in another direction. They can also simply be intermittently displayed (such as faded in and out every so often) instead of scrolled, or otherwise dynamically displayed.

FIG. 8B shows an example of announcement tile 262. When the announcement tile 262 is generated as part of a user interface display 118, the tile illustratively represents a single entity that has a relation to the currently selected entity (such as a single entity associated with the selected “customer” entity). Announcement tile 262 also illustratively includes an announcement that provides the display of activities or announcements made on entities (such as child entities of the selected entity) that are related to the selected customer entity.

FIG. 8B shows one example in which a company (which is the subject of the selected “customer” entity) has a primary contact “Sue Smith”. The primary contact has an associated entity corresponding to a “record wall” and each time a new announcement appears on the “record wall” entity for the primary contact, it is also displayed on announcement tile 262.

In the embodiment shown in FIG. 8B, the top portion of tile 262 includes an image of Sue Smith that illustratively occupies a majority of the tile. This is indicated by numeral 264. Tile 262 also illustratively includes an announcement portion 266 upon which the announcement is displayed. In one embodiment, the announcement can scroll across portion 266, appear as a slide, it can zoom in or out, or it can be displayed in another way. The announcement shown in FIG. 8B is “Sue Smith added as a connection.” The bottom portion of tile 262 includes a related entities identifier 268 that shows the name of related entities that are related to the selected entity. In the embodiment shown in FIG. 8B, the bottom portion of slide 262 also includes a related entity count indicator 270 that identifies a count of related entities for which announcements will be displayed on announcement tile 262.

As one example of the operation of tile 262, any announcement that is made on any of the related entities identified by related entity identifier 268 is displayed on announcement tile 262 in the display portion 266. Any related images are displayed in image portion 264. Therefore, assume that there is an announcement that occurs on all twelve of the related entities. In that case, each time announcement can be displayed in a recurring cycle of announcements in order to increase visual interest in tile 262. For instance, the announcements corresponding to all twelve related entities can be sequentially displayed on tile 262. When an announcement for a related entity is being displayed, the announcement identifier portion 268 is updated to give the name of the entity upon which the announcement appears. As the announcement corresponding to the next entity is displayed, portions 264, 266 and 268 are updated so that portion 264 shows the image of the entity that contains the announcement now being displayed in portion 266, and portion 268 is updated to contain the name of that entity. The user interface component used to generate tile 262 rotates through all of the announcements provided on the twelve related entities.

Again, if the user actuates a portion of tile 262, the user is navigated to the underlying information used to generate the announcements on tile 262. However, the user can get updates or announcements in this way (on announcement tile 262) without actually navigating to the underlying information. This provides a relatively large amount of information in a relatively small space.

FIG. 8C shows a simple icon tile 272. Tile 272 allows the display of iconography, along with the name and count of related entities. In doing so, tile 272 includes an icon display portion 274 that displays an icon representing an entity related to the selected entity. Tile 272 also includes a related entity portion 276 that shows the names of related entities, and a related entities count indicator 278 that shows the number of entities.

It will be noted that simple icon tile 272 can be modified as well. For instance, where tile 272 represents a new message from a customer, the tile can be updated in some way to visually indicate that the message is new. Similarly, this may be done by changing the color of the tile or icon 274. It may be done by displaying a red flag or other visual indicator that the icon is new. Of course, these types of visual indicators can be used to display substantially any type of information. For instance, if the message represented by icon 274 is from an angry customer, the message might be displayed in yellow. If it is from a customer who is extremely angry, it might be displayed in red or with an exclamation mark, or blinking, or in any other way to visually distinguish it to indicate that it is of high importance. Of course, many other visual indicators can be used to indicate other information as well. It should also be noted that these types of visual indicators can be applied to any of the other tiles discussed herein.

FIG. 8D illustrates an action tile 280. Action tile 280 illustratively not only displays information identifying important one-to-one relationships to the selected entity, but it also displays navigable items that allow the user to take direct action on the related entity. In the embodiment shown in FIG. 8D, action tile 280 includes an image portion 282 that shows an image corresponding to the related entity represented by tile 280. It also illustratively includes a summary data portion 284 that provides summary data for the entity represented by tile 280. Tile 280 also illustratively includes action portion 286 that provides user input mechanisms that enable the user to take a given action with respect to the entity represented by tile 280.

In the specific example shown in FIG. 8D, the tile 280 represents the owner (or primary contact) of the selected customer entity. Therefore, image portion 282 is illustratively a photograph of the owner “Sue Smith” of the company represented by the selected entity. Summary portion 284 displays relationship (owner) of the person represented by tile 280 to the selected customer entity and also provides other information, such as the person's name, the person's position and the person's contact number (such as a telephone number).

Action portion 286 in the embodiment shown in FIG. 2D provides three actuable user input buttons 288, 290 and 292 that allow the user to take action with respect to the owner “Sue Smith”. In action portion 286, button 288 navigates the user to an email application with an email template that allows the user to send an email to Sue Smith. Call portion 290 dials a predefined telephone number to enable the user to call Sue Smith and IM button 292 navigates the user to an instant messaging application that allows the user to establish an instant messaging link to Sue Smith, allowing the user to engage in instant messaging with Sue Smith.

It will be noted that information displayed in tile 280 may be obtained by entity/association processing component 112 from a variety of different data records. The information corresponding to buttons 288-292 may exist in three separate data records, for instance, and that data can all be obtained and displayed on tile 280. As the information in the underlying data records is updated, the information displayed on tile 280 is updated as well. Therefore, if Sue Smith changes her email address, and stores the new email address in business data store 104, the new email address will automatically be updated on tile 280 so that when the user actuates button 288, the new email address for Sue Smith will be used.

FIG. 8E shows a time-based info-graphic tile 294. Tile 294 is illustratively generated from records that are linked to the selected customer entity in a time-based relationship, such as with an activities relationship. In the specific example shown in FIG. 8E, line 296 on tile 294 represents the occurrence of activities over time. It can be seen that tile 294 is divided into five business days (Monday-Friday) and line 296 shows that there were spikes in activity with respect to the selected customer entity on Monday, Wednesday and Thursday. For instance, the activities graphed by line 296 in tile 294 might simply include customer contacts (e.g., the number of emails, telephone calls, instant messages, text messages, or other contacts either sent to or received from the customer represented by the selected customer entity). When the user clicks on or otherwise actuates line 296 on one of the days indicated, the user can be navigated to another user interface display that shows the underlying information (such as notes taken from telephone calls to the customer or received from the customer, etc.). FIG. 8E also has an event identifier 298 that provides a name for the events represented by line 296.

The activities discussed with respect to FIG. 8E are exemplary only. They may be different or they may change based on the underlying selected entity. By way of example, if the underlying selected entity is an entity that represents a specific product, then the time-based plot indicated by line 296 might indicate such things as sales or shipments of the specific product. Alternatively, or in addition, it might represent orders placed to vendors for the specific product, or other information as well.

FIG. 8F shows one example of a preview tile 300. Preview tile 300 shows a preview display of a most recent entity represented by tile 300. For example, tile 300 shown in FIG. 8F shows quotes that are related to the selected customer entity. As with some of the other tiles, tile 300 includes a name portion 302 that names the entities represented by tiles 300 and a count indicator 304 that provides the count of the related entities. Since tile 300 represents quotes that are related to the selected customer entity, name portion 302 includes the word “quotes” and count indicator 304 indicates that there are four quotes that have been made to the selected customer, and that are represented by related entities. Preview tile 300 also illustratively includes a preview portion 306 that shows a thumbnail or preview of the most recent of the quotes.

For example, if the user has put together three separate quotes for the customer represented by the selected customer entity, then the most recent of those quotes will be displayed in preview portion 306. Of course, if the user actuates name portion 302 or count indicator 304, the user is navigated to the underlying information and allowed to see any of the quotes represented by tile 300. However, in one embodiment, preview portion 306 only displays a preview of the most recent quote. Tile 300 could be modified as well so that the images displayed in preview portion 306 rotate through the various quotes that have been made, or are otherwise displayed.

It will also be noted that the discussion of the preview tile 300 in FIG. 8F is exemplary only. For instance, if tile 300 represents purchase orders, then the name portion 302 will be updated to “purchase orders” or a similar text string. Similarly, count indicator 304 will be updated to identify the number of purchase orders that have been placed with the underlying selected entity, and preview portion 306 will be updated to show a preview of the most recent purchase order generated for the underlying entity. As the subject matter of the entities represented by tile 300 changes, portions 302, 304 and 306 are changed as well.

FIG. 8G shows area chart tile 310. Area chart tile 310 is illustratively an info-graphic tile that has navigable elements that navigate to corresponding entities. Tile 310 provides generally small, high resolution graphics that are embedded in a context of words, numbers or images to convey information in a concise way. By way of example, tile 310 represents opportunities corresponding to the selected customer entity. Each of the opportunities is also represented by a corresponding entity. In the area chart tile 310, it can be seen that name portion 312 includes a text string identifying the corresponding entities represented by tile 310. Therefore, name portion 312 includes the text string “opportunities”.

Tile 310 also includes a plurality of different chart elements 314, 316 and 318. Element 314 represents closed and unsuccessful opportunities corresponding to the selected customer entity. In one embodiment, element 314 includes text portion 320 that identifies the items represented by element 314 (and thus includes the words “closed unsuccessful”), count indicator 322 includes the number of those items. Therefore, it can be seen that element 314 represents three closed and unsuccessful opportunities that are related to the selected customer entity. Element 316 is similar to element 314, except that the name portion 324 shows that element 316 represents closed and successful opportunities, and count indicator 326 shows that there are six such opportunities represented in the system and identified by tile 310. Finally, element 318 has a name portion 328 that represents active opportunities, and count indicator 330 shows that there is one such opportunity represented by an entity in the system.

Each of the elements 314, 316 and 318 are navigable elements. Therefore, if the user actuates one of them, the user is navigated to the underlying information, such as to the underlying opportunities that are represented by the actuated element.

Again, it will be noted that the tiles shown and discussed with respect to FIGS. 8A-8G are exemplary only. They represent a high density of information in a relatively small space. They are also navigable elements so that when a user actuates one of the tiles, the user is taken to the underlying information used to generate the tiles. This can be done in a wide variety of different ways. For example, where the tiles are displayed on a touch sensitive user interface display screen, the user can actuate one of the navigable elements simply by touching the screen with his or her finger, with a stylus, or otherwise. The tiles can be actuated using a point and click device, such as a mouse, or they can be actuated using a hardware keyboard, a soft keyboard or virtual keyboard, using voice commands, or in other ways. These are discussed by way of example only.

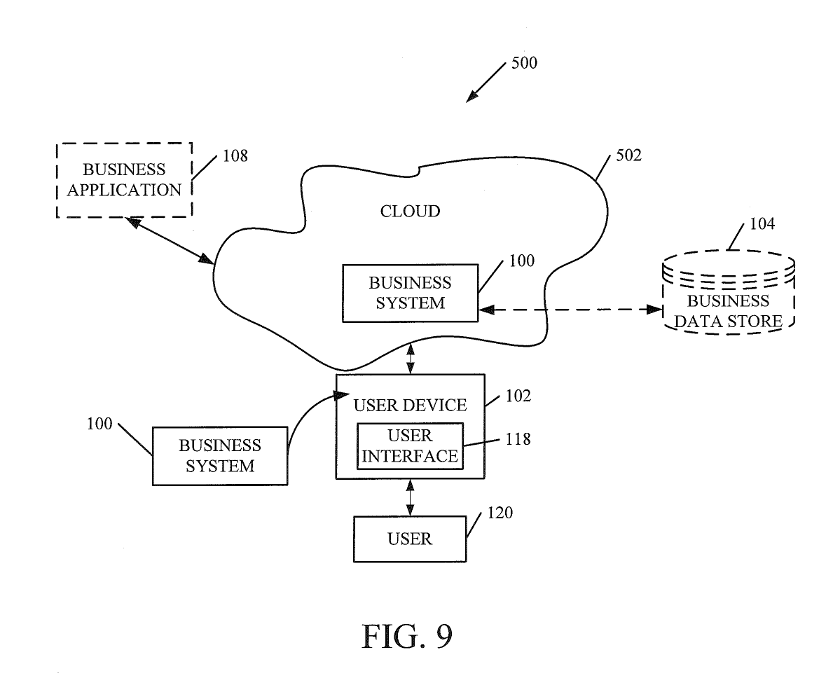

FIG. 9 is a block diagram of system 100, shown in various architectures, including cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

The embodiment shown in FIG. 9, specifically shows that business system 100 is located in cloud 502 (which can be public, private, or a combination where portions are public while others are private). Therefore, user 120 uses a user device 102 to access those systems through cloud 502.

FIG. 9 also depicts another embodiment of a cloud architecture. FIG. 9 shows that it is also contemplated that some elements of business system 100 are disposed in cloud 502 while others are not. By way of example, data store 104 can be disposed outside of cloud 502, and accessed through cloud 502. In another embodiment, some or all of the components of system 100 are also outside of cloud 502. Regardless of where they are located, they can be accessed directly by device 102, through a network (either a wide area network or a local area network), they can be hosted at a remote site by a service, or they can be provided as a service through a cloud or accessed by a connection service that resides in the cloud. FIG. 9 further shows that some or all of the portions of system 100 can be located on device 504. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

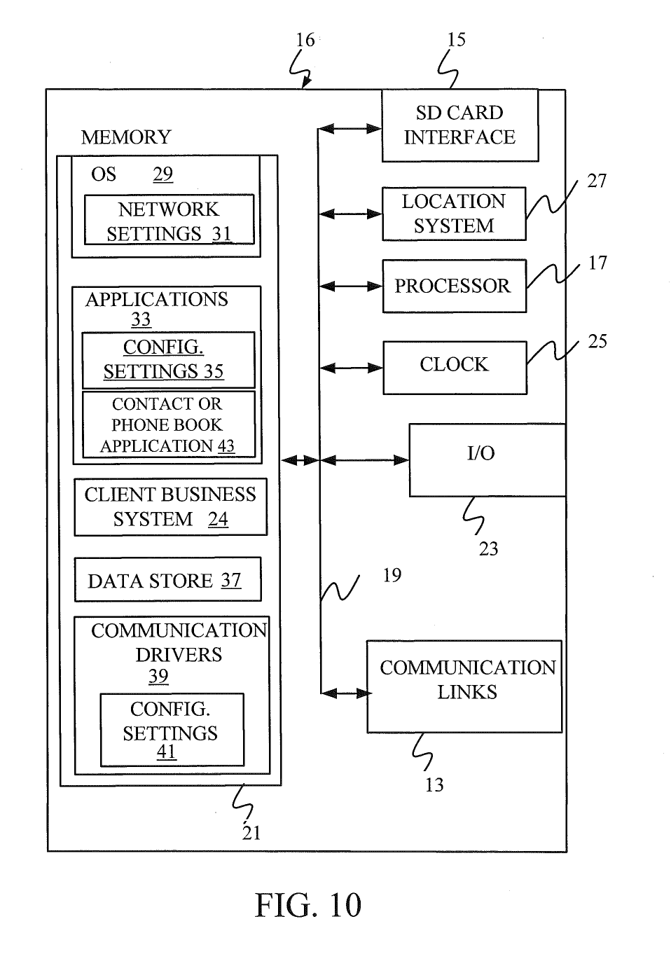

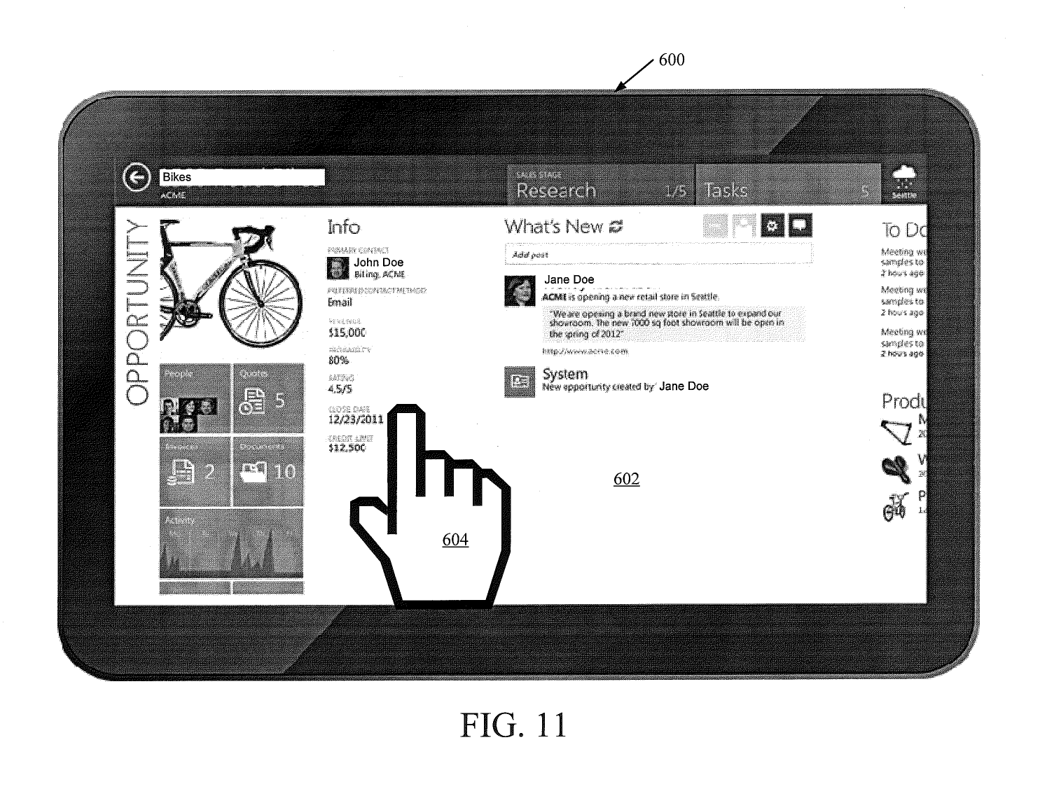

FIG. 10 is a simplified block diagram of one illustrative embodiment of a handheld or mobile computing device that can be used as a user's or client's hand held device 16 (which can be device 102), in which the present system (or parts of it) can be deployed. FIGS. 11-13 are examples of handheld or mobile devices.

FIG. 10 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like system 100) are received on a removable Secure Digital (SD) card that is connected to a SD card interface 15. SD card interface 15 and communication links 13 communicate with a processor 17 (which can also embody processors 106 and/or 114 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. System 100 or the items in data store 104, for example, can reside in memory 21. Similarly, device 16 can have a client business system 24 which can run various business applications or embody parts or all of system 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 11 shows one embodiment in which device 16 is a tablet computer 600. In FIG. 11, computer 600 is shown with display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

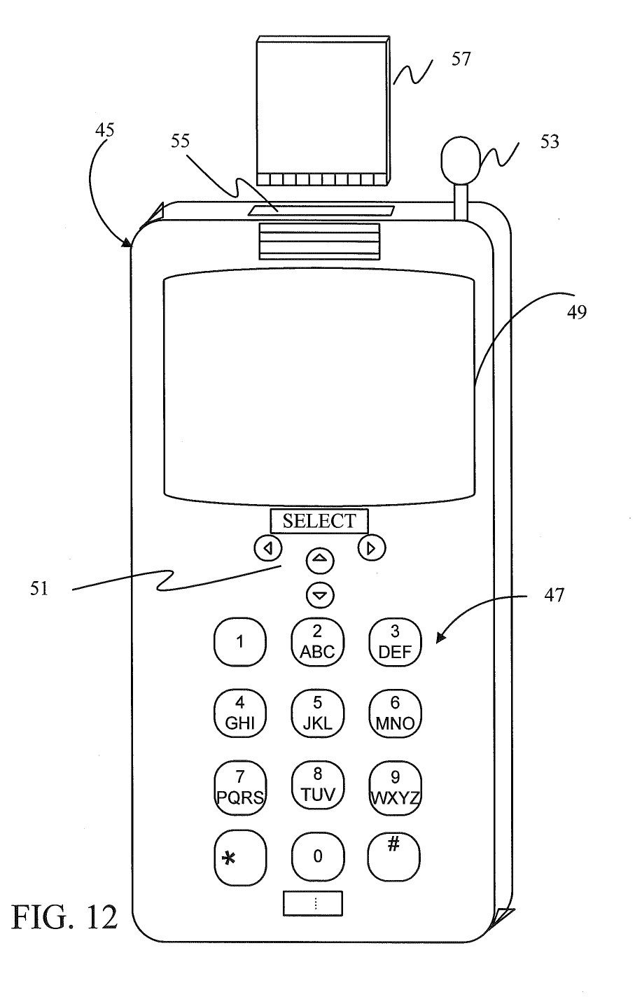

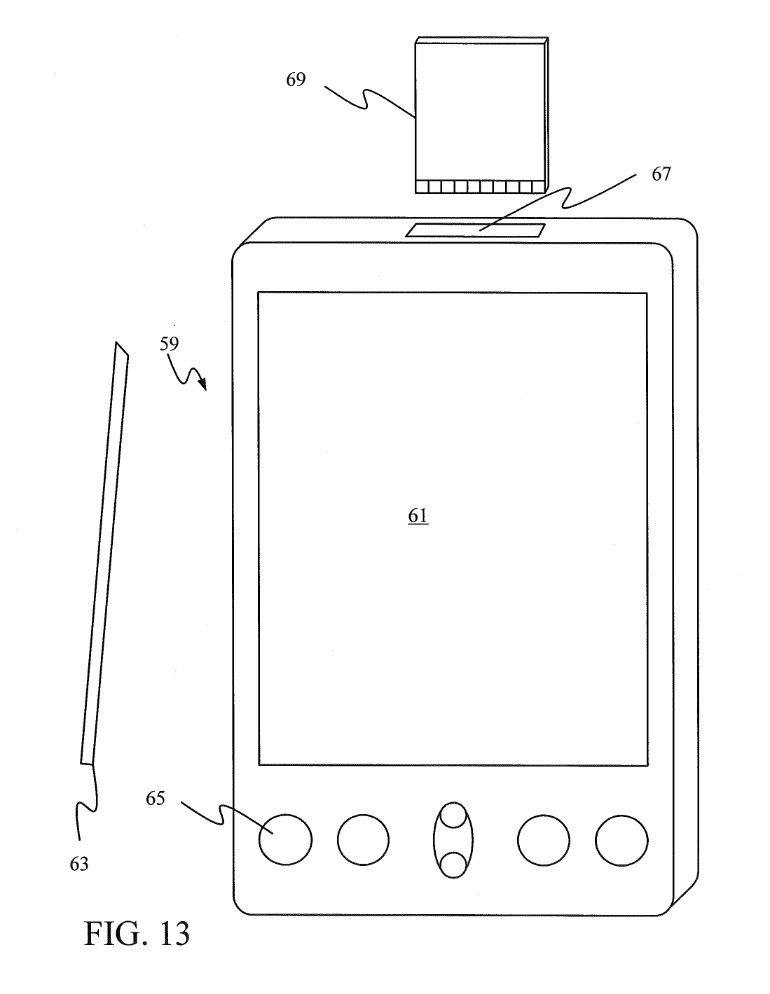

FIGS. 12 and 13 provide additional examples of devices 16 that can be used, although others can be used as well. In FIG. 12, a smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1×rtt, and Short Message Service (SMS) signals. In some embodiments, phone 45 also includes a Secure Digital (SD) card slot 55 that accepts a SD card 57.

The mobile device of FIG. 13 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

Note that other forms of the devices 16 are possible and contemplated herein as well.

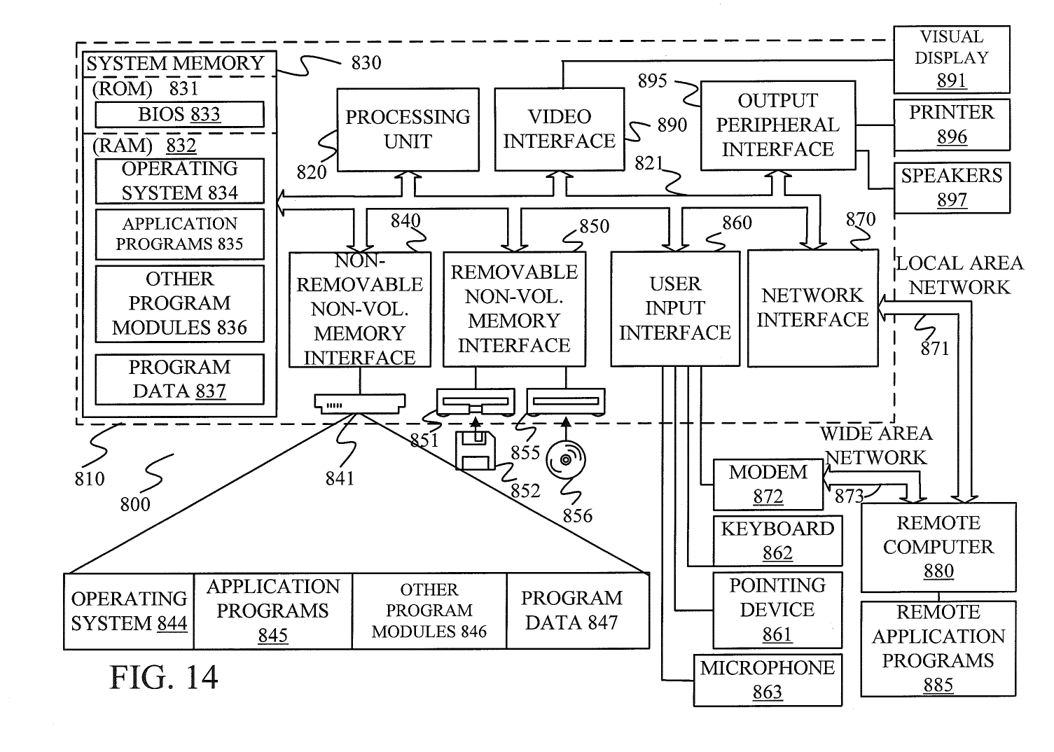

FIG. 14 is one embodiment of a computing environment in which system 100 (for example) can be deployed. With reference to FIG. 14, an exemplary system for implementing some embodiments includes a general-purpose computing device in the form of a computer 810. Components of computer 810 may include, but are not limited to, a processing unit 820 (which can comprise processor 104), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 14.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 14 illustrates operating system 834, application programs 835, other program modules 836, and program data 837.

The computer 810 may also include other removable/non-removable volatile/nonvolatile computer storage media. By way of example only, FIG. 14 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 14, provide storage of computer readable instructions, data structures, program modules and other data for the computer 810. In FIG. 14, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 14 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 14 illustrates remote application programs 885 as residing on remote computer 880. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of displaying information represented by entities, comprising:
receiving a user selection input selecting an entity;
accessing a data store of entities to identify at least a first plurality of related entities and a second plurality of related entities that are related to the selected entity; and
displaying first and second display elements, in a display layout, the first display element displaying information from the first plurality of related entities and the second display element displaying information from the second plurality of related entities, the first display element including a first navigable link which, when actuated by the user, navigates the user to one of the first plurality of related entities, and the second display element including a second navigable link which, when actuated by the user, navigates the user to one of the second plurality of related entities.

2. The computer-implemented method of claim 1 wherein the data store of entities comprises a business data store of business data entities that represent business data records and metadata, the first plurality of related entities comprising a first plurality of related business data entities, the second plurality of related entities comprising a second plurality of related business data entities, and wherein displaying first and second display elements, comprises:
generating the first and second display elements as first and second display tiles displaying business data from the business data records represented by the first and second plurality of related business data entities, respectively; and
displaying the first and second display tiles according to the layout.

3. The computer-implemented method of claim 2 wherein displaying first and second display tiles, comprises:
generating a first info-graphic display tile showing business information from the first plurality of related business data entities and having a navigable link to at least one of the first plurality of related business data entities; and
displaying the first info-graphic display tile.

4. The computer-implemented method of claim 3 wherein generating the first info-graphic display tile comprises:
generating the first info-graphic display tile with a graph display portion that graphs the business information from the first plurality of related business data entities based on graph criteria.

5. The computer-implemented method of claim 4 wherein generating the first info-graphic display tile comprises:
generating the first info-graphic display tile with a graph display portion that graphs the business information from the first plurality of related business data entities according to a time-based graph criteria.

6. The computer-implemented method of claim 4 wherein generating the first info-graphic display tile comprises:
generating the first info-graphic display tile with a graph display portion that graphs the business information from the first plurality of related business data entities according to a volume-based graph criteria.

7. The computer-implemented method of claim 2 wherein displaying first and second display tiles, comprises:
generating a first action display tile showing the business information from the first plurality of related business data entities and having a navigable link which, when actuated by the user, navigates the user to a user interface display to perform an action relative to the selected entity; and
displaying the first action display tile.

8. The computer-implemented method of claim 7 wherein generating the first action display tile comprises:
generating the first action display tile with a plurality of navigable links, each navigating the user to a user interface display for taking a different action on the selected entity.

9. The computer-implemented method of claim 7 wherein the user interface for performing an action comprises a communication user interface for initiating communication.

10. The computer-implemented method of claim 2 wherein displaying first and second display tiles comprises:
generating a first gallery display tile that includes a plurality of different images, each image representing one of the first plurality of related business data entities, the navigable link, when actuated, navigating to the one of the first plurality of related business data entities that the given image represents; and
displaying the first gallery display tile.

11. The computer-implemented method of claim 10 wherein displaying the first gallery tile comprises:
dynamically displaying different ones of the plurality of different images.

12. The computer-implemented method of claim 10 wherein the plurality of different images comprise previews of documents or photographs.

13. The computer-implemented method of claim 2 wherein displaying first and second display tiles comprise:
generating an announcement display tile that includes a plurality of different announcements, each announcement representing information on one of the first plurality of related business data entities; and
displaying the announcement display tile.

14. The computer-implemented method of claim 13 wherein generating an announcement display tile comprises:
generating the announcement display tile from entities related to the selected entity as a child entity.

15. The computer-implemented method of claim 2 wherein displaying the first and second display tiles comprises:
displaying, in the first display tile, a text string indicative of the first plurality of business data entities.

16. The computer-implemented method of claim 15 wherein displaying the first and second display tiles comprises:
displaying, in the first display tile, a count indicator indicative of a number of the first plurality of related business data entities.

17. The computer-implemented method of claim 15 wherein displaying the first and second display tiles comprises:
displaying in the first display tile, a visual indicator visually indicating an urgency of data in a given one of the first plurality of related business entities, a recency of the data in the given one of the first plurality of related business data entities or an importance of the data in the given one of the first plurality of related business data entities.

18. A business system, comprising:
a business application that includes business data entities that are related to one another by an association;
an entity/association processing component that identifies a plurality of different related business data entities that are related to a selected business data entity;
a user interface component that generates a user interface display with a plurality of different display tiles arranged according to a display layout, each display tile displaying data corresponding to a set of the related business data entities and a navigation link which, when actuated, navigates to one of the related business data entities in the set; and
a computer processor, being a functional component of the business system and activated by the business application, the entity/association processing component and the user interface component, to facilitate identifying the plurality of different related business data entities and generating the user interface display.

19. The business system of claim 18 wherein the user interface component generates a first display tile, of the plurality of different display tiles, as an info-graphic display tile that shows a graph that graphs the data corresponding to the set of related business data entities versus time or volume.

20. A computer readable medium that has computer executable instructions which, when executed by a computer, cause the computer to perform a method, comprising:
receiving a user selection input selecting an entity;
accessing a data store of entities to identify at least a first plurality of related entities and a second plurality of related entities that are related to the selected entity, the data store of entities comprising a business data store of business data entities that represent business data records and metadata, the first plurality of related entities comprising a first plurality of related business data entities, the second plurality of related entities comprising a second plurality of related business data entities;
generating first and second display elements as first and second display tiles displaying business data from the business data records represented by the first and second plurality of related business data entities, respectively; and
displaying first and second display tiles, in a display layout, the first display tile displaying the business data from the first plurality of related business data entities and the second display tile displaying the business data from the second plurality of related business data entities, the first display tile including a first navigable link which, when actuated by the user, navigates the user to one of the first plurality of related business data entities, and the second display tile including a second navigable link which, when actuated by the user, navigates the user to one of the second plurality of related business data entities.
